(19) United States
(12) Patent Application Publication
(10) Pub. No.: US 2017/0251694 A1
(43) Pub. Date: Sep. 7, 2017

(54) ICE CREAM INCORPORATING ALCOHOL

(71) Applicant: JBL HOLDINGS, II, INC., Lexington, KY (US)

(72) Inventor: Joseph Brett Langley, Lexington, KY (US)

(21) Appl. No.: 15/519,563

(22) PCT Filed: Oct. 15, 2015
(86) PCT No.: PCT/US15/55708

§ 371 Date: Apr. 17, 2017

Related U.S. Application Data
(60) Provisional application No. 62/064,070, filed on Oct. 15, 2014.

(51) Int. Cl. A23G 9/32; A23G 9/34

(52) U.S. Cl. CPC A23G 9/32; A23G 9/34; A23V 2002/00

(57) ABSTRACT

An ice cream base mix is disclosed including milk, cream, corn syrup, sweetener, stabilizer, flavoring and powder. The stabilizer includes a modified food starch. An ice cream made from the base mix and alcohol is also provided.

### TECHNICAL FIELD

This document relates generally to the specialty food products field and, more particularly, to an ice cream containing alcohol.

### BACKGROUND

Numerous attempts have been made in the past to produce an ice cream incorporating alcohol. To date, it has not been possible to produce high-quality, volume-produced ice cream with greater than 3 percent alcohol by volume that remains sufficiently frozen at a temperature suitable for consumption.

This document relates to an alcohol ice cream of greater than 3 percent alcohol by volume and up to as high as 50 percent alcohol by volume that (a) remains frozen at a temperature suitable for consumption and (b) is particularly suited for commercial production.

### SUMMARY

In accordance with the purposes and benefits described herein, an ice cream base mix is provided. For purposes of this document, a base mix should be considered a liquid form of ice cream without any alcohol. In one possible embodiment, that ice cream base mix comprises about 48.89 to about 52.47 weight percent milk, about 20.03 to about 21.46 week percent cream, about 5.72 to about 6.92 weight percent corn syrup, about 15.50 to about 16.69 weight percent sweetener, about 0.76 to about 0.80 weight percent stabilizer, about 5.25 to about 5.96 weight percent flavoring and about 5.96 to about 7.15 weight percent milk powder.

In one possible embodiment, the base mix flavoring is vanilla and the sweetener is sugar.

In one possible embodiment, the stabilizer includes modified food starch. In another possible embodiment, the stabilizer includes a mixture of modified food starch, mono- and diglycerides, cellulose gum, disodium phosphate, sodium citrate, polysorbate 80 and carrageenan.

In one possible embodiment, the stabilizer is a proprietary formulation made by Tate and Lyle Food Systems of Sycamore, Ill., identified by the material identification number CC 5017.

In accordance with an additional aspect, an ice cream is provided. That ice cream comprises about 98 to about 92 weight percent base mix and about 8 to about 2 weight percent alcohol. In one possible embodiment, the base mix includes a stabilizer. In one possible embodiment, the stabilizer includes a modified food starch. In one possible embodiment, the stabilizer includes a mixture of modified food starch, mono- and diglycerides, cellulose gum, disodium phosphate, sodium citrate, polysorbate 80 and carrageenan. In one possible embodiment, the stabilizer is a modified food starch proprietary formulation about Tate and Lyle food systems Sycamore Ill. identified by material identification number CC 5017.

In one possible embodiment, the ice cream includes 5 to 8 percent alcohol by volume.

In accordance with still another aspect, an ice cream is provided comprising a base mix including a stabilizer and greater than 3 percent alcohol by volume and up to as high as 50 percent alcohol by volume. That stabilizer may include a modified food starch.

In one possible embodiment, the stabilizer comprises a mixture of modified food starch, mono- and diglycerides, cellulose gum, disodium phosphate, sodium citrate, polysorbate 80 and carrageenan. In one possible embodiment, the stabilizer is a modified food starch proprietary formulation made by Tate and Lyle Food Systems of Sycamore, Ill. identified by material identification number CC 5017.

In accordance with still another aspect, an ice cream is provided incorporating alcohol and the modified food starch proprietary formulation CC 5017 as a stabilizer. That alcohol may be selected from a group consisting of whiskey, bourbon, vodka, rum, tequila, liqueurs, other alcoholic beverages and mixtures thereof. Still further, the ice cream may include about 7 percent alcohol by volume.

### BRIEF DESCRIPTION OF THE DRAWING FIGURES

The accompanying drawing figures incorporated herein and forming a part of the specification, illustrate several aspects of an ice cream base mix and an ice cream incorporating alcohol and together with the description serve to explain certain principles thereof. In the drawing:

FIG. 1 is a schematic block diagram of an ice cream base mix production protocol.

FIG. 2 is a schematic block diagram of an ice cream base mix packaging protocol.

FIG. 3 is a schematic block diagram of an alcohol ice cream manufacturing process.

Reference will now be made in detail to the present preferred embodiment of the ice cream base mix and an ice cream incorporating alcohol, examples of which are illustrated in the accompanying drawing figures.

### DETAILED DESCRIPTION

This document relates to a new and improved ice cream base mix as well as to a new and improved ice cream made from that base mix and alcohol. Such an ice cream base mix and ice cream may be gelatin-free if desired and gelatin-free ice cream base mixes and ice creams are embodied herein.

In one possible embodiment, the ice cream base mix comprises about 48.89 to about 52.47 weight percent milk, about 20.03 to about 21.46 weight percent cream, about 5.72 to about 6.92 weight percent corn syrup, about 15.50 to about 16.69 weight percent sweetener, about 0.76 to about 0.80 weight percent stabilizer, about 5.25 to about 5.96 weight percent flavoring and about 5.96 to about 7.15 weight percent milk powder.

In one possible embodiment, the ice cream base mix comprises about 49.84 weight percent milk, about 20.51 weight percent cream, about 6.20 weight percent corn syrup, about 15.74 weight percent sweetener, about 0.78 weight percent stabilizer, about 5.49 weight percent flavoring and about 6.56 weight percent milk powder.

In any embodiment the sweetener may be sugar and the flavoring may be vanilla. Of course, it should be appreciated that other sweeteners and flavorings may be utilized.

In one possible embodiment, the stabilizer includes modified food starch. In another possible embodiment, the stabilizer is a mixture of modified food starch, mono and diglycerides, cellulose gum, disodium phosphate, sodium citrate, polysorbate 80 and carrageenan. In one particularly useful embodiment the stabilizer is a modified food starch proprietary formulation made by Tate and Lyle Food Systems of Sycamore, Ill., and identified by material identification number CC 5017.

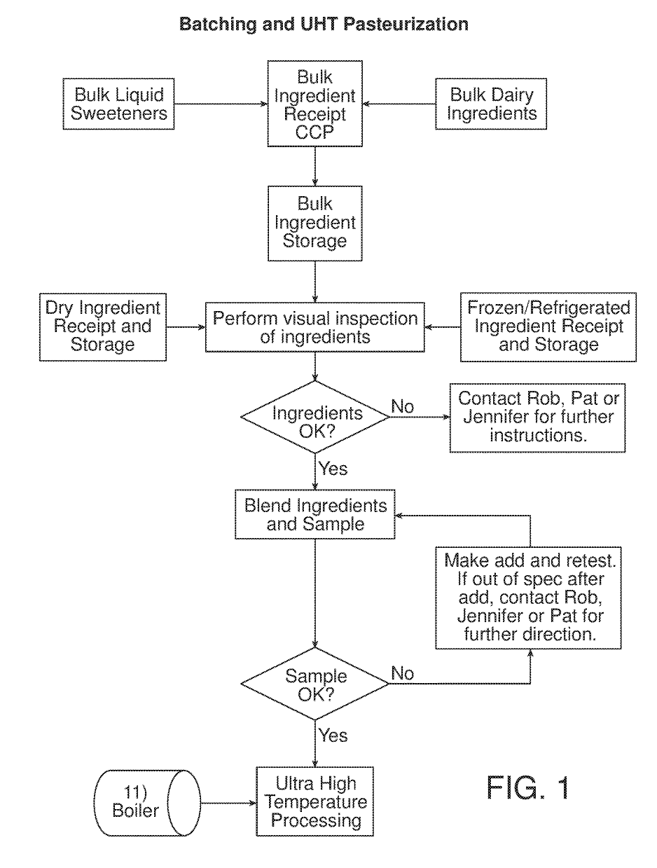

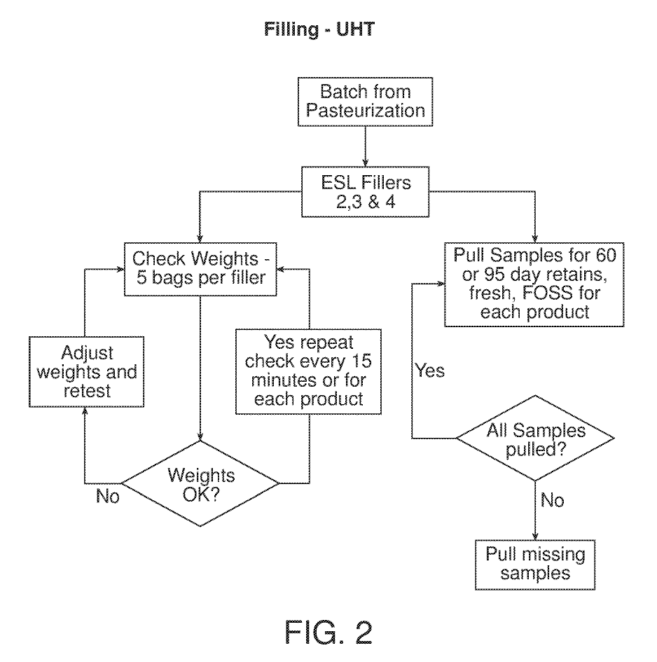

The base mix may be produced in accordance with a production protocol. One such protocol is fully illustrated in FIG. 1. The base mix may be packaged in accordance with a packaging protocol. One such packaging protocol is fully illustrated in FIG. 2.

In addition, an ice cream is provided that includes about 98 to about 92 weight percent base mix and about 8 to about 2 weight percent alcohol. The base mix includes a stabilizer for the alcohol. That stabilizer may include a modified food starch.

In one possible embodiment, that stabilizer includes a mixture of modified food starch, mono and diglycerides, cellulose gum, disodium phosphate, sodium citrate, polysorbate 80 and carrageenan. In one particularly useful embodiment the stabilizer is a modified food starch made by Tate and Lyle Food Systems of Sycamore, Ill., and identified by material identification number CC 5017.

In one possible embodiment, the ice cream includes 5 to 8 percent alcohol by volume. In one possible embodiment the ice cream includes greater than 3 percent alcohol by volume and up to as high as 50 percent alcohol by volume. Accordingly, ice cream embodiments include, but are not necessarily limited to, between 3 to 50 percent alcohol by volume, between 3 to 40 percent alcohol by volume, between 3 to 30 percent alcohol by volume, between 3 to 20 percent alcohol by volume, between 3 to 10 percent alcohol by volume, between 5 to 50 percent alcohol by volume, between 5 to 40 percent alcohol by volume, between 5 to 30 percent alcohol by volume, between 5 to 20 percent alcohol by volume, between 5 to 10 percent alcohol by volume, between 7 to 50 percent alcohol by volume, between 7 to 40 percent alcohol by volume, between 7 to 30 percent alcohol by volume, between 7 to 20 percent alcohol by volume, between 7 to 10 percent alcohol by volume, between 10 to 50 percent alcohol by volume, between 10 to 40 percent alcohol by volume, between 10 to 30 percent alcohol by volume, between 10 to 20 percent alcohol by volume and between 20 to 50 percent alcohol by volume while that ice cream remains frozen at a temperature suitable for consumption. That temperature suitable for consumption may be generally considered to be between −20 degrees Celsius and −12 degrees Celsius, and more particularly between −17.8 degrees Celsius and −15 degrees Celsius.

Further, an ice cream is provided that incorporates alcohol and a stabilizer such as stabilizer CC 5017 as made from Tate and Lyle Food Systems.

In any embodiment, the alcohol may be selected from a group consisting of whiskey, bourbon, vodka, rum, tequila, liqueurs, other alcoholic beverages and mixtures thereof. In other possible embodiments, other types of alcohol may be used. In another possible embodiment, the ice cream includes about 7 percent alcohol by volume. The ice cream includes about 10 weight percent fat.

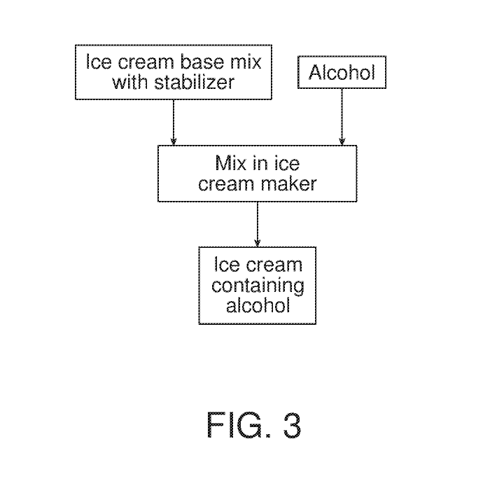

Any of the ice cream formulations disclosed herein may be made by adding an ice cream base mix with stabilizer and alcohol to an ice cream maker and then mixing and processing to obtain the alcohol containing ice cream as illustrated in FIG. 3.

The following examples will help to illustrate the ice cream base mix and the ice cream made from that mix.

### Example 1

Approximately 450 gallons of ice cream base mix was made by mixing/blending 2090 lbs of milk, 860 lbs of cream, 260 lbs of corn syrup, 660 lbs of sugar, 32.6 lbs of CC 5017 stabilizer, 230 lbs of vanilla and 270 lbs of milk powder in a blend tank in accordance with the protocol set forth in FIG. 1.

The mixing/blending continued until a homogeneous mixture was obtained. The homogeneous mixture was then processed in an Ultra High Temperature-Falling Steam Heater (UHT-FSH) unit that runs approximately 3,000 gallons per hour at 280° F. for two seconds. The ice cream base mix was then cooled and filled into 2.5 gallon bags in accordance with the protocol set forth in FIG. 2.

### Example 2

Alcohol ice cream was produced using a Taylor 220 Batch Machine. Ice cream base mix (2.5 gallons) from Example 1 and 0.5 gallons of 90 proof alcohol was added to the batch machine. The batch machine froze the mixture at a temperature of −12° F. The alcohol ice cream was then emptied into a three gallon container and put into a blast freezer overnight at −60° F. The alcohol ice cream was then moved to a normal food freezer and stored at −5° F., ready for serving.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An ice cream base mix, comprising:
about 48.89 to about 52.47 weight percent milk;
about 20.03 to about 21.46 weight percent cream;
about 5.72 to about 6.92 weight percent corn syrup;
about 15.50 to about 16.69 weight percent sweetener;
about 0.76 to about 0.80 weight percent stabilizer;
about 5.25 to about 5.96 weight percent flavoring; and
about 5.96 to about 7.15 weight percent milk powder.

2. The base mix of claim 1, wherein said flavoring is vanilla and said sweetener is sugar.

3. The base mix of claim 1, wherein said stabilizer includes modified food starch.

4. The base mix of claim 1, wherein said stabilizer includes a mixture of modified food starch, mono and diglycerides, cellulose gum, disodium phosphate, sodium citrate, polysorbate 80 and carrageenan.

5. The base mix of claim 1, wherein said stabilizer is CC 5017.

6. An ice cream, comprising:
about 98 to about 50 weight percent base mix; and
about 50 to about 2 weight percent alcohol.

7. The ice cream of claim 6, wherein said base mix includes a stabilizer.

8. The ice cream of claim 7, wherein said stabilizer includes a modified food starch.

9. The ice cream of claim 7, wherein said stabilizer includes a mixture of modified food starch, mono and diglycerides, cellulose gum, disodium phosphate, sodium citrate, polysorbate 80 and carrageenan.

10. The ice cream of claim 7, wherein said stabilizer is CC 5017.

11. The ice cream of claim 7, includes 5 to 8 percent alcohol by volume.

12. An ice cream, comprising:
a base mix including a stabilizer and about 3 to about 50 percent alcohol by volume.

13. The ice cream of claim 12, wherein said stabilizer includes a modified food starch.

14. The ice cream of claim 12, wherein said stabilizer comprises a mixture of modified food starch, mono and diglycerides, cellulose gum, disodium phosphate, sodium citrate, polysorbate 80 and carrageenan.

15. The ice cream of claim 12, wherein said stabilizer is CC 5017.

16. An ice cream, comprising the ice cream base mix of claim 1 and alcohol.

17. An ice cream incorporating CC 5017 as a stabilizer.

18. An ice cream incorporating alcohol and CC 5017 as a stabilizer.

19. The ice cream of claim 18, wherein said alcohol is selected from a group consisting of whiskey, bourbon, vodka, rum, tequila, liqueurs, other alcoholic beverages and mixtures thereof.

20. The ice cream of claim 18 wherein said ice cream includes about 7 percent alcohol by volume.
